(19) United States
(12) Patent Application Publication
(10) Pub. No.: US 2025/0342006 A1
(43) Pub. Date: Nov. 6, 2025

(54) DEVICE AND METHOD WITH IN-MEMORY COMPUTING

(71) Applicants: Samsung Electronics Co., Ltd., Suwon-si (KR); Research & Business Foundation SUNGKYUNKWAN UNIVERSITY, Suwon-si (KR)

(72) Inventors: Kang Eun JEON, Suwon-si (KR); Jong Hwan KO, Suwon-si (KR)

(73) Assignees: Samsung Electronics Co., Ltd., Suwon-si (KR); Research & Business Foundation SUNGKYUNKWAN UNIVERSITY, Suwon-si (KR)

(21) Appl. No.: 19/056,361

(22) Filed: Feb. 18, 2025

(30) Foreign Application Priority Data
May 3, 2024 (KR) 10-2024-0059324

(51) Int. Cl. G06F 7/487; G06F 5/01

(52) U.S. Cl. CPC G06F 7/487; G06F 5/012

(57) ABSTRACT

An in-memory computing (IMC) device includes a controller configured to generate a command signal for a multi-bit representation and a multi-bit operation based on row-column hybrid grouping (RCHG), a memory array configured to store a weight that is used in the multi-bit operation and perform an operation of the weight and an input value, and an operation circuit configured to dynamically control a coefficient by following the multi-bit representation and output a final operation result based on the controlled coefficient and a result of the operation of the weight and the input value.

### CROSS-REFERENCE TO RELATED APPLICATIONS

This application claims the benefit under 35 USC § 119(a) of Korean Patent Application No. 10-2024-0059324, filed on May 3, 2024 in the Korean Intellectual Property Office, the entire disclosure of which is incorporated herein by reference for all purposes.

### BACKGROUND

### 1. Field

The following description relates to a device and method with in-memory computing.

### 2. Description of Related Art

In-memory computing (IMC) is a computing structure that may directly perform operations in memory without moving data and may have an advantage in performing large-scale parallel operations in addition to high energy efficiency due to reduced data movement.

IMC may enable an efficient AI operation and may be used in multiple application devices. IMC technology may enable a real-time AI operation at ultra-low power and may be installed in various sensor products. IMC may be used across AI applications, from mobile to a data center.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an in-memory computing (IMC) device includes a controller configured to generate a command signal for a multi-bit representation and a multi-bit operation based on row-column hybrid grouping (RCHG), a memory array configured to store a weight that is used in the multi-bit operation and perform an operation of the weight and an input value, and an operation circuit configured to dynamically control a coefficient by following the multi-bit representation and output a final operation result based on the controlled coefficient and a result of the operation of the weight and the input value.

For the generating of the command signal, the controller may be configured to generate a command signal that selectively activates or deactivates determined memory cells in the memory array.

For the generating of the command signal, the controller may be configured to generate, using a predetermined operation, a command signal that optimizes allocation of the weight to the memory array.

The predetermined operation may include an operation of generating an RCHG code based on a quantization range condition of a result that is extracted in response to a row of the weight being sequentially truncated.

For the outputting of the final operation result, the operation circuit may include a rank multiplier configured to operate, based on the operation result received from the memory array and the command signal received from the controller, the coefficient and results of the operation of the weight and the input value.

The operation circuit may include a column select circuit configured to, for the outputting of the final operation result, select, based on column accumulation operation results received from the memory array and the command signal received from the controller, operation results of a column to be used in an operation from among the column accumulation operation results.

For the outputting of the final operation result, the operation circuit may include a row select circuit configured to control, based on results of the operation of the weight and the input value received from the memory array and the command signal received from the controller, a coefficient according to a number of rows to be used in an operation.

The operation circuit may include an add-and-shift peripheral structure configured to, for the outputting of the final operation result, perform coefficient control.

The IMC device may include a word line (WL) driver configured to receive a command signal related to the RCHG from the controller and apply the weight to the memory array.

In one or more general aspects, an in-memory computing (IMC) method includes generating a command signal for a multi-bit representation and a multi-bit operation based on row-column hybrid grouping (RCHG), storing a weight that is used in the multi-bit operation in a memory array based on the command signal, performing an operation of the stored weight and an input value, and outputting a final operation result based on a coefficient dynamically controlled by following the multi-bit representation and a result of the operation of the stored weight and the input value.

The generating of the command signal may include generating a command signal that selectively activates or deactivates determined memory cells in the memory array.

The generating of the command signal may include generating, using a predetermined operation, a command signal that optimizes allocation of the weight to the memory array.

The predetermined operation may include an operation of generating an RCHG code based on a quantization range condition of a result that is extracted in response to a row of the weight being sequentially truncated.

The outputting of the final operation result may include operating, based on the operation result received from the memory array and the command signal, the coefficient and results of the operation of the stored weight and the input value.

The outputting of the final operation result may include selecting, based on column accumulation operation results received from the memory array and the command signal, operation results of a column to be used in an operation from among the column accumulation operation results.

The outputting of the final operation result may include controlling, based on results of the operation of the stored weight and the input value received from the memory array and the command signal, a coefficient according to a number of rows to be used in an operation.

The outputting of the final operation result may include performing a coefficient multiplication through an add-and-shift peripheral circuit configured to perform coefficient control.

In one or more general aspects, a non-transitory computer-readable storage medium may store instructions that, when executed by one or more processors, configure the one or more processors to perform any one, any combination, or all of operations and/or methods disclosed herein.

In one or more general aspects, an in-memory computing (IMC) method includes quantizing a floating-point number representing a weight of a neural network to a first integer, generating a row-column hybrid grouping (RCHG) command signal for a first row of a memory cell by binarizing the first integer, quantizing the floating-point number to a second integer, removing an integer value of the first integer from an integer value of the second integer, generating an RCHG command signal for a second row of the memory cell by binarizing a result of the removing of the integer value, and generating an RCHG command signal for a multi-bit representation and a multi-bit operation of the weight based on the RCHG command signal for the first row and RCHG command signal for the second row.

The IMC method may include storing the weight in the memory array based on the RCHG command signal for the multi-bit representation and the multi-bit operation of the weight, performing an operation of the stored weight and an input value, and outputting a final operation result based on a coefficient dynamically controlled by following the multi-bit representation and a result of the operation of the stored weight and the input value.

Other features and aspects will be apparent from the following detailed description, the drawings, and the claims.

### BRIEF DESCRIPTION OF THE DRAWINGS

FIG. 1 illustrates an example of a column grouping method.

FIG. 2 illustrates an example of an in-memory computing (IMC) device that performs row-column hybrid grouping (RCHG).

FIG. 3 illustrates examples of RCHG.

FIG. 4 illustrates an example of row truncation or column truncation.

FIG. 5 illustrates a flowchart of an example of a method of generating an RCHG code.

FIGS. 6A to 8 illustrate examples of an operation circuit.

FIG. 9 illustrates an example of an operation of an operation circuit.

FIGS. 10A to 10C illustrate examples of a method of implementing an operation circuit.

FIG. 11 illustrates a flowchart of an example of an IMC method.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the state.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms used herein including technical and scientific terms have the same meanings as those commonly understood by one of ordinary skill in the art to which this disclosure pertains and based on an understanding of the disclosure of the present application. Terms such as those defined in commonly used dictionaries are to be interpreted as having a meaning that is consistent with their meaning in the context of the relevant art and the disclosure of the present application, and are not to be interpreted in an idealized or overly formal sense unless expressly so defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The examples may be implemented as various types of products such as, for example, a personal computer (PC), a laptop computer, a tablet computer, a smartphone, a television (TV), a smart home appliance, an intelligent vehicle, a kiosk, a wearable device, and the like. Hereinafter, the examples are described in detail with reference to the accompanying drawings. When describing the examples with reference to the accompanying drawings, like reference numerals refer to like components and a repeated description related thereto is omitted.

In-memory computing (IMC) is a computation method that significantly improves data processing speed and performance by processing data directly in memory instead of a traditional disk-based storage. IMC may quickly analyze and process a large amount of data in real time through a high-speed memory access. A high-speed data access may be important in a large-scale data analysis and real-time data analysis. IMC may reduce a need for disk input/output operations when storing and retrieving data, improve application performance, and facilitate system maintenance and management.

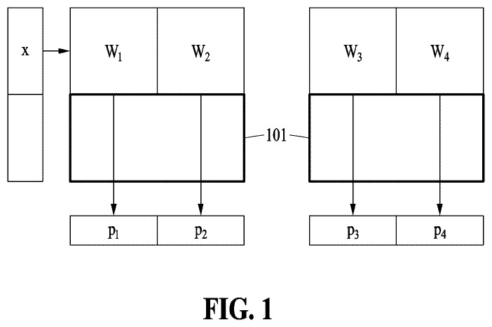

FIG. 1 illustrates an example of a column grouping method.

Referring to FIG. 1, a column grouping multi-bit weight representation may be a method used for neural network weight acceleration. When applying a convolutional layer or linear layer that uses a kernel splitting (KS) mapping technique to a column grouping method, array utilization may decrease and computing cycles may increase.

IMC may operate an input value x and a weight wᵢ∈{i|0, 1, . . . , L_{c}−1} using a column grouping method and output a partial sum (e.g., p₁, p₂, . . . , and p_{Lc-1}). In column grouping, a leftmost bit may be a most significant bit (MSB), and a rightmost bit may be the least significant bit (LSB). Thus, in IMC using a column grouping method, even when an operation close to the rightmost bit is omitted, a final result may not be significantly affected. However, in a typical column grouping method, operation inefficiency may occur since memory cells are present that are not used for operations, such as an inactive memory cell 101.

On the contrary, unlike the typical column grouping method, a typical row grouping method does not distinguish between an MSB and an LSB. Thus, there may be a limitation to implementing the typical row grouping method in IMC, as IMC involves omitting a portion of memory cells to increase operation speed.

In contrast to the typical column grouping method and the typical row grouping method, an IMC method of one or more embodiments described below may include a row-column hybrid grouping (RCHG) method, therefore solving the issues of the typical column grouping method and the typical row grouping method and increasing a usage rate of a memory array.

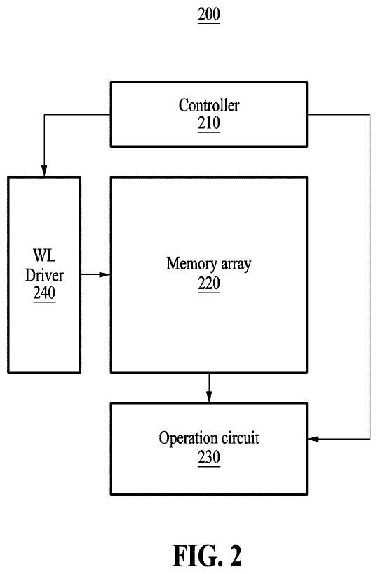

FIG. 2 illustrates an example of an IMC device 200 that performs RCHG.

One or more blocks shown in FIG. 2 or a combination thereof may be implemented by a special-purpose hardware-based computer that performs a predetermined function or implements computer instructions.

Referring to FIG. 2, the IMC device 200 may include a controller 210 (e.g., one or more processors) that generates a command signal for a multi-bit representation and a multi-bit operation based on RCHG. The IMC device 200 may include a memory array 220 that stores a weight used in a multi-bit operation and performs an operation of the weight and an input value. The IMC device 200 may include an operation circuit 230 that dynamically controls a coefficient by following a multi-bit representation and outputs a final operation result based on an operation result and the controlled coefficient. The IMC device 200 may include a word line (WL) driver 240 that receives a command signal related to RCHG from the controller 210 and applies a weight to the memory array 220.

A multi-bit weight representation (MWR) may refer to a method of using multiple bits for one value to express data or a weight mainly in a neural network. Each bit may represent a value in a binary number system. The MWR may increase precision and express a wider range of numbers. For example, when using 8 bits, 256 different values may be represented, which may store more information than a single bit.

The controller 210 may generate a command signal to selectively activate or deactivate specific memory cells in the memory array 220. The controller 210 may dynamically generate an RCHG code and appropriately allocate a multi-bit weight to the memory array 220 to perform row truncation or column truncation in RCHG. The controller 210 may generate a command signal that optimizes weight allocation to the memory array 220 using a predetermined method. The predetermined method may generate the RCHG code based on a quantization range condition of a result extracted when a row of the weight is sequentially truncated. In an example, the controller 210 may be or include a memory controller, a memory chip controller (MCC), a memory controller unit (MCU), and/or an integrated memory controller.

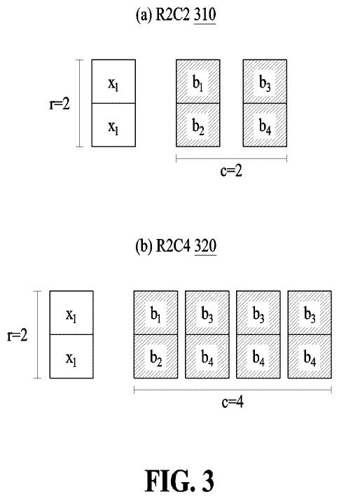

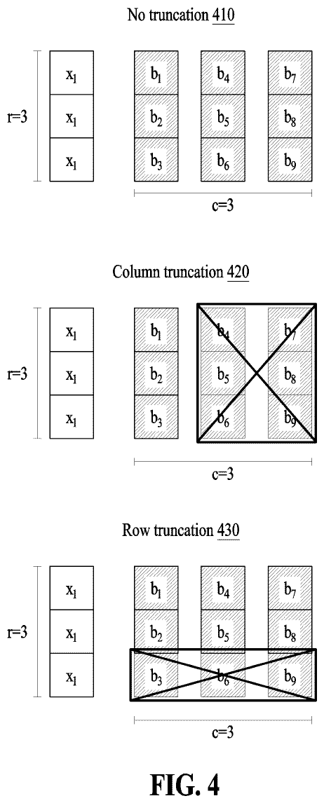

An example of RCHG is described with reference to FIGS. 3 and 4. RCHG may refer to using a row and a column simultaneously in a method for data storage and processing. An RCHG method of one or more embodiments may efficiently store and process data or information such as the weight in the memory array 220.

The operation circuit 230 may include a rank-multiplier that operates, based on the operation result received from the memory array 220 and the command signal received from the controller 210, operation results and the coefficient. The operation circuit 230 may include a column select circuit that selects, based on the operation result received from the memory array 220 and the command signal received from the controller 210, operation results of a row to be used in an operation from among operation results. The operation circuit 230 may include a row select circuit that controls a coefficient according to a number of rows to be used in an operation among the operation results based on the operation results received from the memory array 220 and the command signal received from the controller 210.

FIG. 3 illustrates examples of RCHG.

The description provided with reference to FIG. 2 may apply to FIG. 3, and any repeated description related thereto may be omitted.

Referring to FIG. 3, examples of an R2C2 method 310 using two rows and two columns and an R2C4 method 320 using two rows and four columns are shown. In RCHG, a same input value (x₁) may be copied and applied to two grouped rows to use more rows. For example, a coefficient of each row may be a same coefficient and may be “1.” In this case, two memory cells mapped to each column may be decimal numbers or thermometer codes. Here, a number of numerals that may be represented by a decimal code used in r rows and one column may be r(L−1)+1. Here, L denotes a number of levels that one memory cell may represent. When these binary codes are tied to a column c and represent one weight, the number of numerals that may be expressed may be (r(L−1)+1))^{c}.

For example, in the R2C2 method 310, when it is assumed there is two Ls, the number of numerals that may be expressed by a decimal code mapped to one column may be 3 (e.g., 0, 1, and 2) and accordingly, a total of 3³=9 numerals may be expressed. Likewise, in the R2C2 method 320, when it is assumed that there is two Ls, the number of numerals that may be expressed by the decimal code mapped to one column may be 3 (e.g., 0, 1, and 2) and accordingly, a total of 3⁴=81 numerals may be expressed.

FIG. 4 illustrates an example of row reduction or column reduction.

The description provided with reference to FIGS. 2 to 3 may apply to FIG. 4, and any repeated description related thereto may be omitted.

Referring to FIG. 4, a column or row truncation method of R3C3 in RCHG is shown. For example, no truncation 410 shows that no truncation of a row or a column has occurred. Here, since the number of numerals that may be expressed in each column may be 4 (e.g., 0, 1, 2, and 3), a total of 64 numerals may be expressed. The IMC device 200 may perform column truncation 420 and row truncation 430. Referring to the examples of FIG. 4, since a second column and a third column are deleted in the column truncation 420 and a third row is deleted in the row truncation 430, a bit storing an important value may not be used in operations. Therefore, in order to perform column truncation and/or row truncation, an optimization method of one or more embodiments may be used to appropriately allocate multi-bit weights to the memory array 220 to prevent missing an important value in operations.

The IMC device 200 may generate an RCHG code that allocates weights to the memory array 220. Referring again to FIG. 4, when a column corresponding to an LSB is truncated or a row corresponding to the LSB is truncated in the RCHG performed by the IMC device 200, an important bit may not be used in operations. For example, when the memory array 220 has R2C1 RCHG and L is 1, there may be two ways (e.g., [0, 1] and [1, 0]) to express 1 in the R2C1 RCHG. When a row corresponding to an LSB of codes expressed as [0, 1] or [1, 0] is truncated, [0, 1] may be expressed as 0, and [1, 0] may be expressed as 1. In this case, an issue of inconsistency between operation results of the memory array 220 may occur. In another example, row truncation in which two rows are truncated to one row may be a process of converting a ternary number to a binary number.

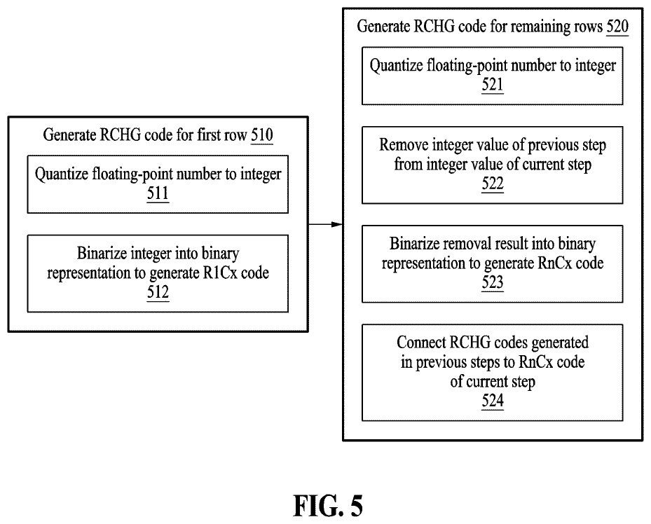

Thus, in IMC, a method of one or more embodiments may generate an RCHG code and may appropriately allocate multi-bit values to the memory array 220 such that a size relationship of weights that are operated and quantized in the memory array 220 may be appropriately maintained even when the row truncation 430 occurs. The RCHG code may be generated in a predetermined way that uses a quantization range condition. The quantization range condition may be a condition that requires overlapping of quantization ranges of a truncation code, which may be determined when rows of a corresponding code are sequentially truncated. Further, the overlapping quantization range may be adopted as a quantization range of the corresponding code. In certain codes, quantization ranges of a truncation code may not overlap, and such codes may be considered invalid codes that may not be used. An example of a method of generating an RCHG code is described in detail with reference to FIG. 5.

FIG. 5 illustrates a flowchart of an example of a method of generating an RCHG code. Operations 510, 511, 512, 520, 521, 522, 523, and 524 to be described hereinafter may be performed sequentially in the order and manner as shown and described below with reference to FIG. 5, but the order of one or more of the operations may be changed, one or more of the operations may be omitted, and two or more of the operations may be performed in parallel or simultaneously without departing from the spirit and scope of the example embodiments described herein.

The description provided with reference to FIGS. 1 to 4 may apply to FIG. 5, and any repeated description related thereto may be omitted.

The IMC device 200 may perform operations 510 and 520 to generate an RCHG code. In an example, the IMC device 200 generates an R2C4 RCHG code in the form shown in Table 1 below, for example.

TABLE 1

| | | | |
|---|---|---|---|
| W_{1, 4} | W_{1, 3} | W_{1, 2} | W_{1, 1} |
| W_{2, 4} | W_{2, 3} | W_{2, 2} | W_{2, 1} |

In operation 510, the IMC device 200 may generate an RCHG code for a first row. The IMC device 200 may perform operations 511 and 512 as a first step to generate the RCHG code for the first row.

In operation 511, the IMC device 200 may quantize a floating-point number to an integer. A neural network weight may be expressed using a floating point. Further, when loading a weight into the memory array 220, a floating-point weight may be quantized, expressed as an integer value, and stored in the memory array 220. Accordingly, the IMC device 200 may generate an RCHG code corresponding to the floating-point weight when generating the RCHG code.

For example, when the IMC device 200 quantizes a floating-point number 0.4 to an integer in R1C4, a maximum integer value that R1C4 may express is 15, and Q₁=q(0.4, 15)=6 may be determined when using a quantization function q. Here, a quantization function may be a round function or a floor function. The round function may be q(w_{f}, L)=round(w_{f}×L). The floor function may be q(w_{f}, L)=floor(w_{f}×(L+1)). The quantization function is not limited to the described example and may be performed using other quantization functions known to those skilled in the art. Accordingly, the IMC device 200 may quantize a floating-point number to an integer value.

In operation 512, the IMC device 200 may binarize the quantized integer into a binary representation to generate an R1Cx code. As in the above-mentioned example, in the case of R1C4, when the floating point is quantized to 6, the IMC device 200 may perform a binarization operation to change 6 to a binary number. Accordingly, the IMC device 200 may output a binarization result of f(6, b=2)=0110₂. The IMC device 200 may input the output binarization result to the memory array 220 as shown in Table 2 below, for example.

TABLE 2

| | | | |
|---|---|---|---|
| W_{1, 4} = 0 | W_{1, 3} = 1 | W_{1, 2} = 1 | W_{1, 1} = 0 |

In operation 520, the IMC device 200 may generate an RCHG code for remaining rows. After performing operation 510 for generating an RCHG code, the IMC device 200 may repeatedly perform operations 521 to 524 included in operation 520 for the remaining rows. However, for ease of description, the described example may be an example of generating an R2C4 code.

In operation 521, the IMC device 200 may quantize a floating-point number to an integer. For example, since the floating-point number is assumed to be 0.4 and a maximum integer value that may be expressed in R2C4 is 31, Q₂=q(0.4, 31)=12 may be determined when using the quantization function q.

In operation 522, the IMC device 200 may remove an integer value of a previous step from an integer value of a current step. For example, since the integer value of the current step may be Q₂=12 and the integer value of the previous step may be Q₁=6, Q₂−Q₁=6 may be determined.

In operation 523, the IMC device 200 may binarize a removal result into a binary representation to generate an RnCx code. For example, since the current step is for generating an RCHG code for a second row, the IMC device 200 may output a binarization result of the R2C4 code, which may be f(6, b=2)=0110₂. Accordingly, the IMC device 200 may obtain the R2C4 code as shown in Table 3 below, for example.

TABLE 3

| | | | |
|---|---|---|---|
| W_{2, 4} = 0 | W_{2, 3} = 1 | W_{2, 2} = 1 | W_{2, 1} = 0 |

In operation 524, the IMC device 200 may connect the RCHG codes generated in previous steps to the RnCx code of the current step. For example, in the current step, R2C4, which is the RCHG code for the second row, may be generated as shown in Table 3. The IMC device 200 may connect Table 2 with Table 3 to generate the RCHG code as shown in Table 4 below, for example.

TABLE 4

| | | | |
|---|---|---|---|
| 0 | 1 | 1 | 0 |
| 0 | 1 | 1 | 0 |

When the RCHG code does not end in two rows and has remaining rows, the IMC device 200 may repeatedly perform operation 520 described above on the remaining rows to finally generate an RCHG code of RnCx.

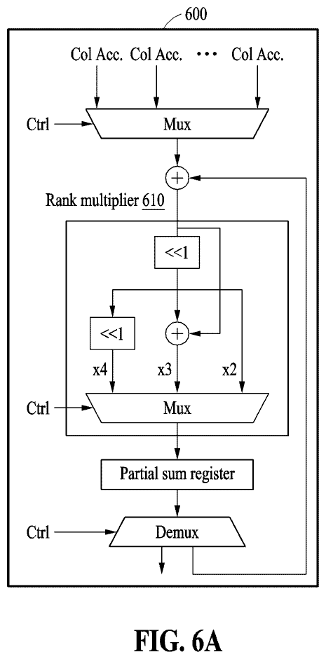

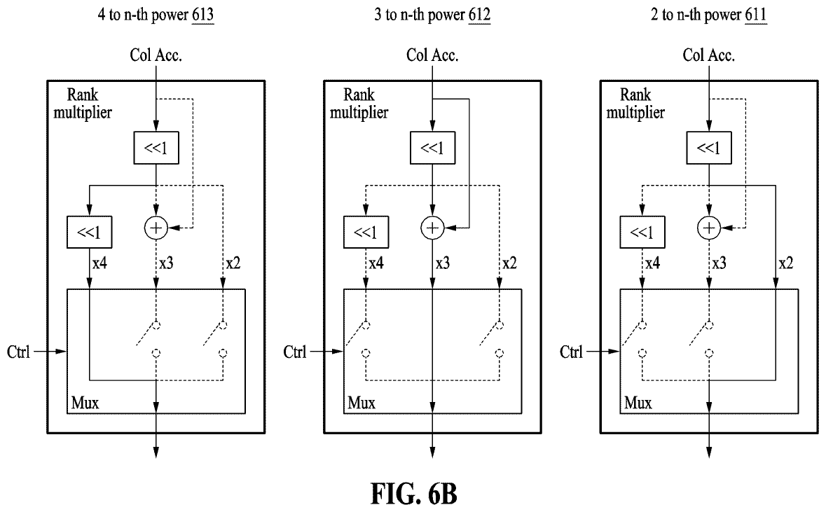

FIGS. 6A to 8 illustrate examples of an operation circuit.

The description provided with reference to FIGS. 2 to 5 may apply to FIGS. 6 to 8, and any repeated description related thereto may be omitted.

One or more blocks shown in FIGS. 6A to 8, or a combination thereof may be implemented by a special-purpose hardware-based computer that performs a predetermined function or instructions.

Referring to FIG. 6A, an operation circuit 600 (e.g., the operation circuit 230 of FIG. 2) may include a rank multiplier 610. The rank multiplier 610 may include an add-and-shift peripheral circuit configured to perform coefficient control. In each drawing, + is a schematic diagram of an add circuit, and << is a simplified schematic diagram of a shift circuit. For example, <<1 indicates one shift, and <<2 indicates two shifts.

In a typical add-and-shift peripheral circuit, a coefficient of each column is an n-th power of 2, so a coefficient multiplication operation may be implemented through a shift operation. However, in order to perform a coefficient multiplication operation based on RCHG in the described examples, a coefficient to be multiplied may vary depending on a number of truncated rows. For example, when three rows are used, the coefficient may be 4, but when one row is truncated and two rows are used, the coefficient may be 3. Thus, a device of one or more embodiments may include an add-and-shift peripheral circuit structure configured to perform coefficient control to support an operation of an RCHG method, which may be truncated or expanded.

In the operation circuit 600, a multiplexer (Mux) may be a device that selects one of received inputs and transmits the one received input to one output line. A demultiplexer (Demux) may generate multiple outputs from one input and select one output to output. A partial sum register may be a register that stores an intermediate operation result value. The partial sum register may be a register that stores the intermediate operation result to be reused.

The examples of FIG. 6B are examples of operations of the rank multiplier 610 of the operation circuit 600 that supports coefficients of 2 to the n-th power, 3 to the n-th power, and 4 to the n-th power. A case of 2 to the n-th power 611 may be implemented by the rank multiplier 610 receiving a column accumulation value and performing only a shift operation on the column accumulation value. A case of 3 to the n-th power 612 may be implemented by adding an output of a shifted adder and the received column accumulation value. A case of 4 to the n-th power 613 may be implemented by shifting the column accumulation value twice.

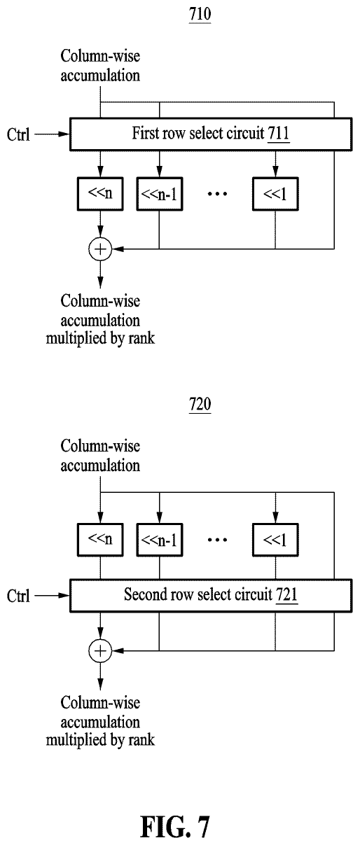

Referring to FIG. 7, an example of an operation of a row select circuit included in the operation circuit 230 is schematically illustrated. The row select circuit may be a device to support row truncation and may control a coefficient operation to be performed by a rank multiplier according to a number of truncated rows. For example, in an operation for an R3Cx code, the row select circuit may support a coefficient operation of 4 to the n-th power when row truncation does not occur in the row select circuit, support a coefficient operation of 3 to the n-th power when a third row is truncated, and support a coefficient operation of 2 to the n-th power when the third row and a second row are truncated.

The row select circuit may operate before or after the operation of the rank multiplier in the operation circuit 230. For example, the operation circuit 230 may be implemented in a form of a first rank multiplier 710 or a second rank multiplier 720. A first row select circuit 711 of the operation circuit 230 may perform row selection before a shift-and-add operation of the first rank multiplier 710. In another example, a second row select circuit 721 of the operation circuit 230 may perform row selection after a shift-and-add operation of the second rank multiplier 720. The rank multiplier may operate so that a weight may be adjusted by multiplying partial sums, which are operation results received from the memory array 220, by a determined coefficient according to the operation of the row select circuit.

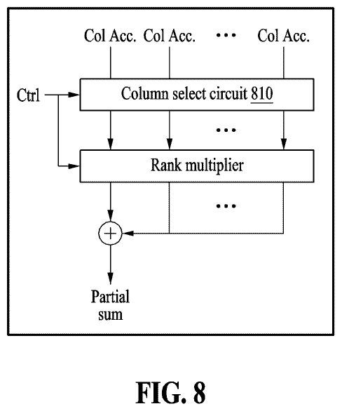

Referring to FIG. 8, the operation circuit 230 may further include a column select circuit 810. The column select circuit 810 may be a component to support column truncation and may select a column accumulation value of a column that is not truncated to transmit the value to a rank multiplier. However, when column truncation is not necessary (e.g., when only one column is used as in RxC1), the column select circuit 810 may not be needed.

The column select circuit 810 may receive a command regarding column truncation or expansion from the controller 210 and transmit a data operation result (e.g., column accumulation) stored in the corresponding column to the rank multiplier. The rank multiplier may determine a value of a coefficient by which to multiply partial sums and may output a resulting value of multiplying the coefficient, according to the operation of the row select circuit described above. The rank multiplier may be implemented by combining a column select circuit and a row select circuit.

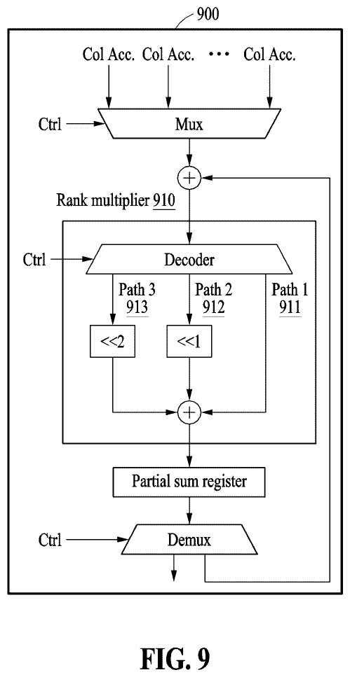

FIG. 9 illustrates an example of an operation of an operation circuit.

The description provided with reference to FIGS. 2 to 8 may apply to FIG. 9, and any repeated description related thereto may be omitted.

Referring to FIG. 9, an operation circuit 900 (e.g., the operation circuit 230 of FIG. 2) may be implemented using a decoder. The decoder may generate multiple outputs from one input and select one or several of the multiple outputs to output. A column accumulation (Col Acc) value selected by a Mux may be added to a previously stored partial sum and transmitted to a rank multiplier. When there is no previously stored partial sum, only the selected Col Acc value may be transmitted. Thereafter, a rank multiplier 910 may perform a shift operation according to a coefficient determined according to a row used in the operation. For example, in a case of a coefficient operation of 2 to the n-th power, only a Path 2 912 may be activated and accordingly, the coefficient operation of 2 to the n-th power may be performed through one shift. In another example, in a case of a coefficient operation of 3 to the n-th power, a Path 1 911 and the Path 2 912 may be activated, output values of the Path 1 911 and the Path 2 912 may be added, and a new intermediate operation result value may be transmitted to a partial sum register. In another example, in a case of a coefficient operation of 4 to the n-th power, a Path 3 913 may be activated and accordingly, the coefficient operation of 4 to the n-th power may be performed through two shifts.

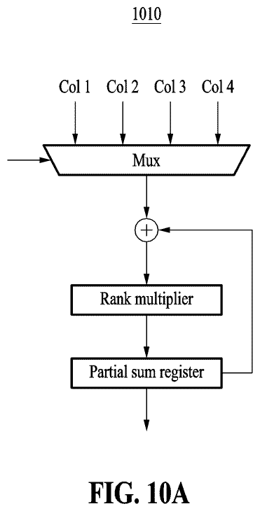

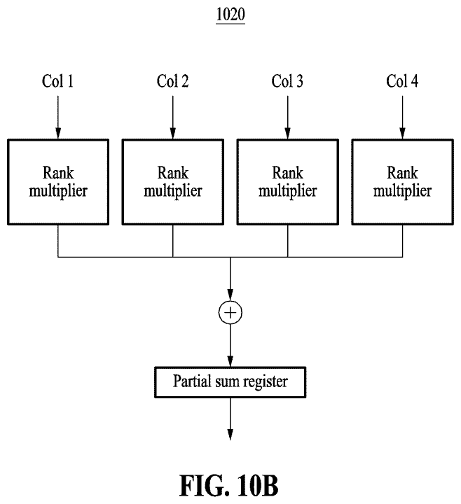

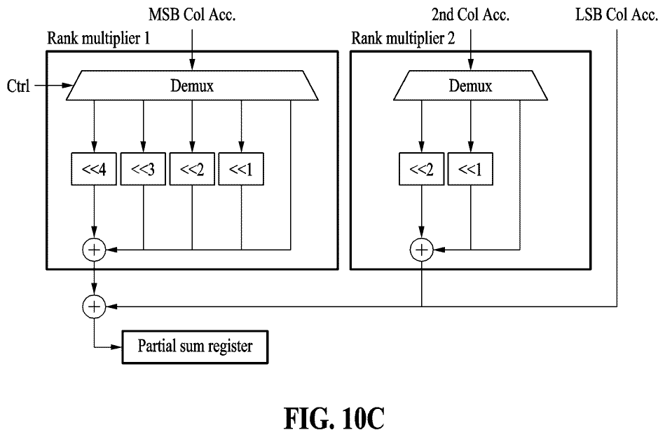

FIGS. 10A to 10C illustrate examples of a method of implementing an operation circuit.

The description provided with reference to FIGS. 2 to 9 may apply to FIGS. 10A to 10C, and any repeated description related thereto may be omitted.

Referring to FIG. 10A, the operation circuit 230 may be implemented as a bit-serial operation structure 1010. The bit-serial operation structure 1010 may be implemented in a form in which multiple columns share one rank multiplier. The example of FIG. 10A is a case in which four columns are grouped, and the four grouped columns may express one neural network weight. For example, in a first cycle, a value of Col 1 may be selected by a Mux and input to the rank multiplier. A resulting value of multiplying the value of Col 1 by a coefficient in the rank multiplier may be stored in a partial sum register. In a second cycle, a value of Col 2 may be selected by the Mux and added to an intermediate operation result value of a previous cycle that was previously stored in the partial sum register. Thereafter, a resulting value of multiplying a value input to the rank multiplier by a coefficient may be stored again in the partial sum register. This process may be repeated up to Col 4 to output a final result. Here, when column truncation is performed and only up to Col 3 is activated and connected to the Mux, the above-mentioned process may be performed 3 times, and when row truncation is performed and only 2 rows remain, a value of a coefficient by which to multiply in the rank multiplier may be 2 to the n-th power.

Referring to FIG. 10B, the operation circuit 230 may be implemented as a bit-parallel operation structure 1020. In the bit-parallel operation structure 1020, separate rank multipliers may be present for each column and accordingly, a coefficient operation of the rank multipliers may be performed in parallel for each column, rather than sequentially. Thus, referring to FIG. 10C, the rank multipliers of the bit-parallel operation structure 1020 may not be implemented in a same form but be implemented as rank multipliers that support different coefficient operations. The coefficient operation of each rank multiplier may operate independently according to the method described above.

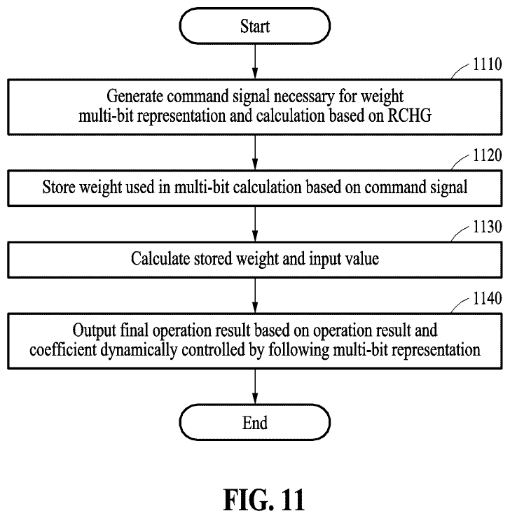

FIG. 11 illustrates a flowchart of an example of an IMC method.

The description provided with reference to FIGS. 2 to 10C may apply to FIG. 11, and any repeated description related thereto may be omitted.

Operations 1110 to 1140 of FIG. 11 to be described hereinafter may be performed sequentially in the order and manner as shown and described below with reference to FIG. 11, but the order of one or more of the operations may be changed, one or more of the operations may be omitted, and two or more of the operations may be performed in parallel or simultaneously without departing from the spirit and scope of the example embodiments described herein.

In operation 1110, the IMC device 200 may generate a command signal for a weight multi-bit representation and operation based on RCHG. The IMC device 200 may generate a command signal that selectively activates or deactivates determined memory cells in the memory array 220. The IMC device 200 may generate a command signal that optimizes weight allocation in the memory array 220 using a predetermined method. The predetermined method may include a method of generating an RCHG code based on a quantization range condition of a result extracted when a row of the weight is sequentially truncated.

In operation 1120, the IMC device 200 may store a weight used in a multi-bit operation based on the command signal.

In operation 1130, the IMC device 200 may perform an operation of the stored weight and an input value.

In operation 1140, the IMC device 200 may output a final operation result based on an operation result and a coefficient dynamically controlled by following a multi-bit representation. The IMC device 200 may operate, based on the operation result received from the memory array 220 and the received coefficient operation command signal, operation results and the coefficient. The IMC device 200 may select, from among the operation results, operation results of a column to be used in an operation based on a column accumulation operation result received from the memory array 220 and the received command signal. The IMC device 200 may control a coefficient according to a number of rows to be used in an operation among the operation results based on the column accumulation operation results received from the memory array 220 and the received command signal. The IMC device 200 may perform a coefficient multiplication through an add-and-shift peripheral circuit configured to perform coefficient control.

The inactive memory cells, IMC devices, controllers, memory arrays, operation circuits, WL drivers, rank multipliers, first rank multipliers, second rank multipliers, first row select circuits, second row select circuits, column select circuits, bit-serial operation structures, bit-parallel operation structures, inactive memory cell 101, IMC device 200, controller 210, memory array 220, operation circuit 230, WL driver 240, operation circuit 600, rank multiplier 610, first rank multiplier 710, second rank multiplier 720, first row select circuit 711, second row select circuit 721, column select circuit 810, operation circuit 900, rank multiplier 910, bit-serial operation structure 1010, and bit-parallel operation structure 1020 described herein, including descriptions with respect to respect to FIGS. 1-11, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-11 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RW, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An in-memory computing (IMC) device comprising:
a controller configured to generate a command signal for a multi-bit representation and a multi-bit operation based on row-column hybrid grouping (RCHG);
a memory array configured to store a weight that is used in the multi-bit operation and perform an operation of the weight and an input value; and
an operation circuit configured to dynamically control a coefficient by following the multi-bit representation and output a final operation result based on the controlled coefficient and a result of the operation of the weight and the input value.

2. The IMC device of claim 1, wherein, for the generating of the command signal, the controller is configured to generate a command signal that selectively activates or deactivates determined memory cells in the memory array.

3. The IMC device of claim 1, wherein, for the generating of the command signal, the controller is configured to generate, using a predetermined operation, a command signal that optimizes allocation of the weight to the memory array.

4. The IMC device of claim 3, wherein the predetermined operation comprises an operation of generating an RCHG code based on a quantization range condition of a result that is extracted in response to a row of the weight being sequentially truncated.

5. The IMC device of claim 1, wherein, for the outputting of the final operation result, the operation circuit comprises a rank multiplier configured to operate, based on the operation result received from the memory array and the command signal received from the controller, the coefficient and results of the operation of the weight and the input value.

6. The IMC device of claim 1, wherein the operation circuit comprises a column select circuit configured to, for the outputting of the final operation result, select, based on column accumulation operation results received from the memory array and the command signal received from the controller, operation results of a column to be used in an operation from among the column accumulation operation results.

7. The IMC device of claim 1, wherein, for the outputting of the final operation result, the operation circuit comprises a row select circuit configured to control, based on results of the operation of the weight and the input value received from the memory array and the command signal received from the controller, a coefficient according to a number of rows to be used in an operation.

8. The IMC device of claim 1, wherein the operation circuit comprises an add-and-shift peripheral structure configured to, for the outputting of the final operation result, perform coefficient control.

9. The IMC device of claim 1, further comprising a word line (WL) driver configured to receive a command signal related to the RCHG from the controller and apply the weight to the memory array.

10. An in-memory computing (IMC) method comprising:
generating a command signal for a multi-bit representation and a multi-bit operation based on row-column hybrid grouping (RCHG);
storing a weight that is used in the multi-bit operation in a memory array based on the command signal;
performing an operation of the stored weight and an input value; and
outputting a final operation result based on a coefficient dynamically controlled by following the multi-bit representation and a result of the operation of the stored weight and the input value.

11. The IMC method of claim 10, wherein the generating of the command signal comprises generating a command signal that selectively activates or deactivates determined memory cells in the memory array.

12. The IMC method of claim 10, wherein the generating of the command signal comprises generating, using a predetermined operation, a command signal that optimizes allocation of the weight to the memory array.

13. The IMC method of claim 12, wherein the predetermined operation comprises an operation of generating an RCHG code based on a quantization range condition of a result that is extracted in response to a row of the weight being sequentially truncated.

14. The IMC method of claim 10, wherein the outputting of the final operation result comprises operating, based on the operation result received from the memory array and the command signal, the coefficient and results of the operation of the stored weight and the input value.

15. The IMC method of claim 10, wherein the outputting of the final operation result comprises selecting, based on column accumulation operation results received from the memory array and the command signal, operation results of a column to be used in an operation from among the column accumulation operation results.

16. The IMC method of claim 10, wherein the outputting of the final operation result comprises controlling, based on results of the operation of the stored weight and the input value received from the memory array and the command signal, a coefficient according to a number of rows to be used in an operation.

17. The IMC method of claim 10, wherein the outputting of the final operation result comprises performing a coefficient multiplication through an add-and-shift peripheral circuit configured to perform coefficient control.

18. A non-transitory computer-readable storage medium storing instructions that, when executed by one or more processors, configure the one or more processors to perform the method of claim 10.

19. An in-memory computing (IMC) method comprising:
quantizing a floating-point number representing a weight of a neural network to a first integer;
generating a row-column hybrid grouping (RCHG) command signal for a first row of a memory cell by binarizing the first integer;
quantizing the floating-point number to a second integer;
removing an integer value of the first integer from an integer value of the second integer;
generating an RCHG command signal for a second row of the memory cell by binarizing a result of the removing of the integer value; and
generating an RCHG command signal for a multi-bit representation and a multi-bit operation of the weight based on the RCHG command signal for the first row and RCHG command signal for the second row.

20. The IMC method of claim 19, further comprising:
storing the weight in the memory array based on the RCHG command signal for the multi-bit representation and the multi-bit operation of the weight;
performing an operation of the stored weight and an input value; and
outputting a final operation result based on a coefficient dynamically controlled by following the multi-bit representation and a result of the operation of the stored weight and the input value.
